(19) United States
(12) Patent Application Publication
(10) Pub. No.: US 2011/0231768 A1
(43) Pub. Date: Sep. 22, 2011

(54) Systems and Methods for Suggestive Redirection

(76) Inventor: Tom C. Tovar, San Francisco, CA (US)

(21) Appl. No.: 12/896,822

(22) Filed: Oct. 1, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/177; G06F 3/01

(52) U.S. Cl. 715/735

(57) ABSTRACT

A system for suggestive redirection includes a user interface module to provide a user interface between a network user with administrative authority and an Internet service, a communication module to receive a request to establish a redirection policy from the network user with administrative authority, a policy generating module to establish the redirection policy, and a policy enforcement module to apply the redirection policy to a user request to access an intended content. The policy enforcement module determines whether or not the redirection policy is in effect to redirect the network user to the suggestive online content. The suggestive online content may provide a hint or suggest a vacation, a purchase, a healthy habit, an activity, or an event. A policy enforcement module may determine that the redirection policy is activated, determine that the intended content is to be redirected under the redirection policy, and, based on the determination, selectively redirect the network user to the suggestive online content.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

This application relates generally to data processing and more specifically to systems and methods for suggestive redirection.

### BACKGROUND

Emails, social media postings, tweets, instant messages, Short Message Service (SMS), and many other message delivering mechanisms may refer online content by providing links within the body of a message. The sender's most likely intent is that the recipient access the content referred to in the message. However, because a further action is required on the recipient's part to access the content (i.e., clicking the link), the recipient remains entirely free to ignore or miss the link. Thus, even though the sender may attempt to influence a recipient's decision, ultimately, he or she has no control over the recipient's Internet experience.

### SUMMARY OF THE INVENTION

Various exemplary embodiments of the present invention illustrate systems and methods for suggestive redirection of a second end user request to Internet content determined by a first end user. The suggestive redirection may apply to Internet service delivered to the home, residence, business or other locations as defined by an end user with administrative authority. Such systems and methods are tools for communication to other members of a network in a playful way.

The system may provide policies that guide various user queries. Various embodiments of the systems and methods may include policy modules implementing suggestive redirection. In one exemplary embodiment, a system for suggestive redirection may include a user interface module to provide a user interface between a network user with administrative authority and an Internet service, a communication module to receive a request to establish a redirection policy from the network user with administrative authority, a policy generating module to establish the redirection policy, and a policy enforcement module to apply the redirection policy to a user request to access an intended content, wherein the policy enforcement module determines whether or not the redirection policy is in effect to redirect the network user to the suggestive online content.

The suggestive online content may include a specific site. The specific site may be used as a hint to suggest a vacation, a purchase, a healthy habit, an activity, or an event. A policy enforcement module may determine that the redirection policy is activated, determine that the intended content is to be redirected under the redirection policy, and, based on a determination, selectively redirecting the network user to the suggestive online content.

The system may include a user interface that allows the end user with administrative authority to personalize the content, and establish the conditions of use, of the Internet content to be delivered. The user interface may operate between an end user and an Internet service provider. For purposes of this disclosure, the definition of Internet service provider will include any service or technology that provides a connection to the Internet. Examples of such technologies include, but are not limited to, traditional Internet service providers (ISPs), telecommunications companies, cable operators, mobile operators, network operators, and any other provider of wired or wireless access to Internet services. The system may be set up to run to utilize a DNS (Domain Name System) server, resolver, or a cloud based networking system.

The system may include one or more policy applications that allow a user to selectively manage at least a portion of an Internet service received by that end user or home network. The policy applications may be discrete applications and may be single purpose applications. The applications may be configured to meet the needs, rules, and behaviors desired by the end user.

The user may select one or more policy applications from a selection menu to provide an individualized Internet experience for the end user or his household.

The end user may select the policy applications that he wants to apply to his Internet service. The selections may be made using at least one of the Internet access devices available to the user and the user interface. The policies contained in the policy applications are applied to the Internet service that is supplied to the end user. Policies may include specific sites that can or cannot be accessed. Policies may also include time and duration of access, and limitations and restrictions specific to a given user or to the home network generally. It should be noted that the policy applications may be used to not only prohibit undesired behaviors, but may also be used to encourage desired behaviors. Other users within a home network may be redirected to sites other than those chosen based on a policy application applied by the user.

Feedback about the Internet service may be made available to the end user, such as to a person designated as the administrator of the system. The feedback may include a listing of sites that are accessed, access attempts for sites that are blocked, duration and time of use of each site, and which access device was used to access each site. The feedback may further include identification of the specific user who accessed the Internet.

Information about the personalization settings of an end user may be shared with third parties. A user may publish to friends or other third parties the policy applications they are using, and/or which policies he has in place. Similarly, the user may access information from third parties, such as which policies they are using, which policy applications they find useful, and so forth.

The user interface as well as the suggestive online content may be accessed through a gateway available to any user. Gateways may include but are not limited to desktops, PCs, laptops, tablets, notebooks, game consoles (e.g., an X-box), IPods, Smartphone and Internet enabled TVs. The system may also be accessed and controlled through remote control means, such as a Smartphone. A Smartphone may be generally defined as a phone with computing capability. A Smartphone may provide Internet access to a user.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of a redirection engine, in accordance with various embodiments of the present technology.

FIG. 2 illustrates a flow chart of a method for suggestive redirection.

FIG. 3 is a screenshot of a description associated with a redirection policy application.

FIG. 4 is a screenshot of a configuration webpage associated with a redirection policy application.

FIG. 5 is a screenshot of a confirmation overlay.

FIG. 6 is a block diagram of a Domain Name Server (DNS) environment.

FIG. 7 is a block diagram of a system within which a redirection policy is implemented.

FIG. 8 is a computing system that may be used to implement the methods for suggestive redirection.

### DETAILED DESCRIPTION

Generally speaking, an administrator may create and enforce value-based mediation polices for one or more end users that utilize computing deices coupled to an Internet service delivered to a location such as a home residence, place of business, campus, etc. The term “administrator” may include not only individuals, such as parent, but also any individual creating value-based mediation policies regarding the Internet service delivered to end users. It will be understood that an administrator may also be an end user, although end users who are not also administrators may not create mediation policies.

It will be further understood that because of the diversity of computing devices that may connect to the Internet service, the mediation policy may be applied to the Internet service rather than requiring the mediation policy to affect each computing device individually, such as a mediation application resident on each computing device. A policy may also reside as a stand alone application on one or more of the computing devices.

Systems and methods for suggestive redirection may be used to strengthen personal relationships through digital gestures and suggestions by allowing Internet users to use specific websites to suggest or highlight desired outcomes or actions.

By redirecting another person, the sender may signal reconciliation or make a romantic gesture. For example, systems and methods for suggestive redirection may be used to suggest vacations, events, purchases, provide helpful hints, suggest healthy habits, guide specific decisions (such as choice of schools, sports, and so forth), settle bets or highlight activities and programs.

The systems and methods may allow a network user with administrative authority to redirect the recipient user directly to particular Internet content instead of that intended by the second end user. Whereas a link inside a message is easily ignored when presented in an email, text message, or by other message sending means, this action may be carried out in lieu of or immediately before completing the recipient users request, thus preventing the recipient from missing or ignoring the sender's wishes.

Thus, systems and methods for suggestive redirection may enable a network user with administrative privileges to redirect others to a chosen content. In some exemplary embodiments, the recipient may be informed that the network user with the administrative authority intended the redirection action to take place. In some exemplary embodiments, a particular redirection is limited to a predetermined number of occurrences.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

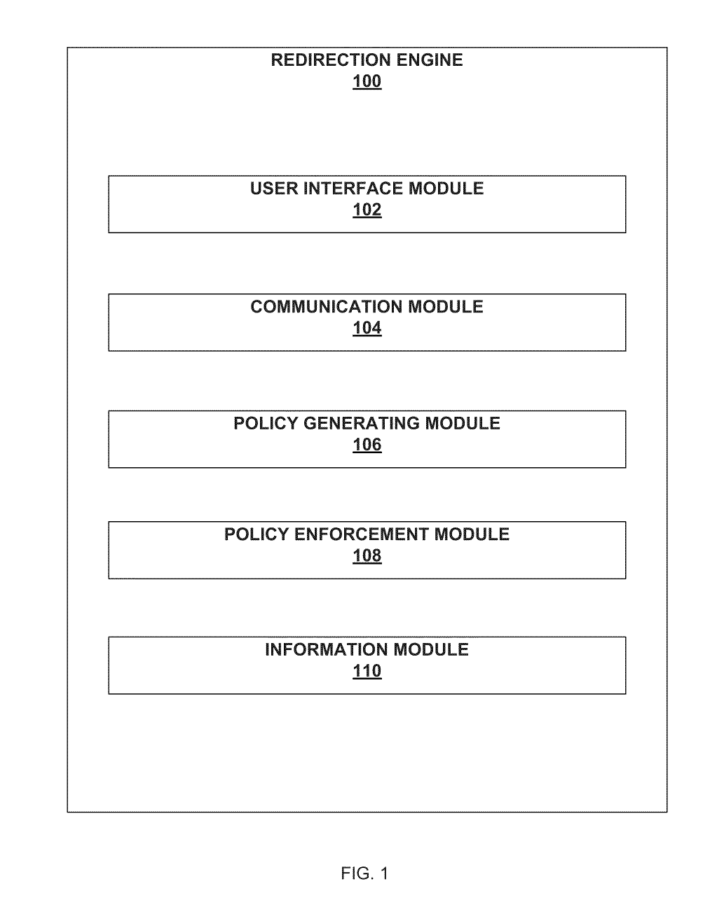

FIG. 1 is a block diagram of a redirection engine 100, in accordance with various exemplary embodiments of the technology. Alternative embodiments of the redirection policy system may comprise more, less, or functionally equivalent modules. In some exemplary embodiments, the redirection engine 100 comprises a user interface module 102, a communication module 104, a policy generating module 106, a policy enforcement module 108, and an information module 110. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

Internet content may also include Internet content collaboratively determined by a group of end users invited by the administrator to collaborate on the establishment of the Internet content records used in the mediation policy. The administrator may, before or after the administrator creates the administrator's own mediation policy, invite the administrator's family members, friends, colleagues or any group of combination of groups and individuals to identify Internet content to be used by the administrator in creating the administrator's own mediation policy. These invitees may or may not be users of the Internet service but will be allowed to contribute to the administrator's mediation policy via the user interface of the Internet service. The administrator may choose to moderate the contributions of individuals or groups invited by the administrator to contribute to the administrator's mediation policy. The administrator may also, before or after the administrator creates the administrator's own mediation policy, join an existing group of users of the Internet service and apply the determinations of age appropriate Internet content by a group to the administrator's own mediation policy. Where there is an existing group that the administrator joins for purposes of creating a mediation policy, the administrator may choose to import the contributions of other groups once or subscribe to these groups to reduce the configuration burden of creating a mediation policy. After the administrator creates the administrator's own mediation policy, the administrator may publish the administrator's mediation policy to be used and/or subscribed to by other users of the Internet service. In such case, other users of the Internet service may import the contributions of administrator once or subscribe to the administrator's mediation policy for use in their own mediation policies. It is understood that via this collaboration two or more user-administrators may combine their mediation policies to create one mediation policy that may be used by these and other administrators of the Internet service.

The user interface module 102 may be configurable to establish the user interface 710, which may be utilized by a network user 660 with administrative authority at the user device 650. The user interface 710 generated by the user interface module 102 may include a brief application description and one or more configuration prompts permitting the network user 660 with administrative authority to activate and deactivate the redirection policy, for example, by using ON and OFF buttons.

The communication module 104 may be configurable to provide a communication channel between the various components of the redirection engine 100 and the user interface 710. Additionally, the communication module 104 may enable direct exchange of information between various modules of the redirection engine 100. For example, the communication module 104 may facilitate receiving activation and deactivation requests provided by the network user 660 with administrative authority via the user interface 710. In response to the network user 660 with administrative authority clicking the ON button, the policy generating module 106 may activate the redirection policy.

In some exemplary embodiments, clicking ON or OFF buttons may not automatically activate or deactivate the associated redirection policy. Therefore, the policy generating module 106 may be utilized to activate the redirection policy (e.g., by clicking the OK button). The policy generating module 106 may be utilized any time the network user 660 with administrative authority decides to terminate the redirection policy.

By allowing the network user 660 with administrative authority to redirect another network user to a specific content, the redirection engine 100 may enable suggesting a particular action (e.g., a vacation). For example, redirecting to a travel planning site may signal readiness by the network user to take that particular action. Thus, systems and methods for suggestive redirection may allow for strengthening personal relationships, spending more time together, and suggesting activities, events and programs.

Other exemplary applications of the methods and systems described herein may include suggesting trying a new restaurant or booking a weekend getaway. Siblings may play pranks on one another or make suggestions to one another. Parents may suggest joint activities to their children. A father may suggest that he and his son go to an upcoming baseball game by redirecting a son's website request to the official team website. A mother may find out there's a new museum exhibit or concert this upcoming weekend and send her daughter a hint by redirecting her website access attempts to the museum or concert website. In some cases, the goal may be to surprise the child with the chance to go to a positive and fun event and, ultimately, spend more time together.

Couples and roommates or any co-habitants without children may promote activities or events (such as taking a trip, or trying a new sport), or suggest a change in habits by redirecting other users to websites that embody the suggestion.

The network user 660 with administrative authority may not need to take any affirmative action to activate the redirection policy. Instead, the redirection policy may be activated by default once the network user 660 with administrative authority opts to deploy the application 720 at the DNS network 640. Alternatively, in some exemplary embodiments, the application 720 may be preinstalled at the DNS network 640 (whether activated or not).

Once the redirection policy is activated and the network user 660 attempts to access an online content, the policy enforcement module 108 may determine whether or not the content is subject to redirection. Upon such determination, the policy enforcement module 108 may enforce the redirection policy by redirecting the network user 660 to a predetermined content. The policy information module 110 may be utilized to inform the network user 660 by whom the redirection was requested.

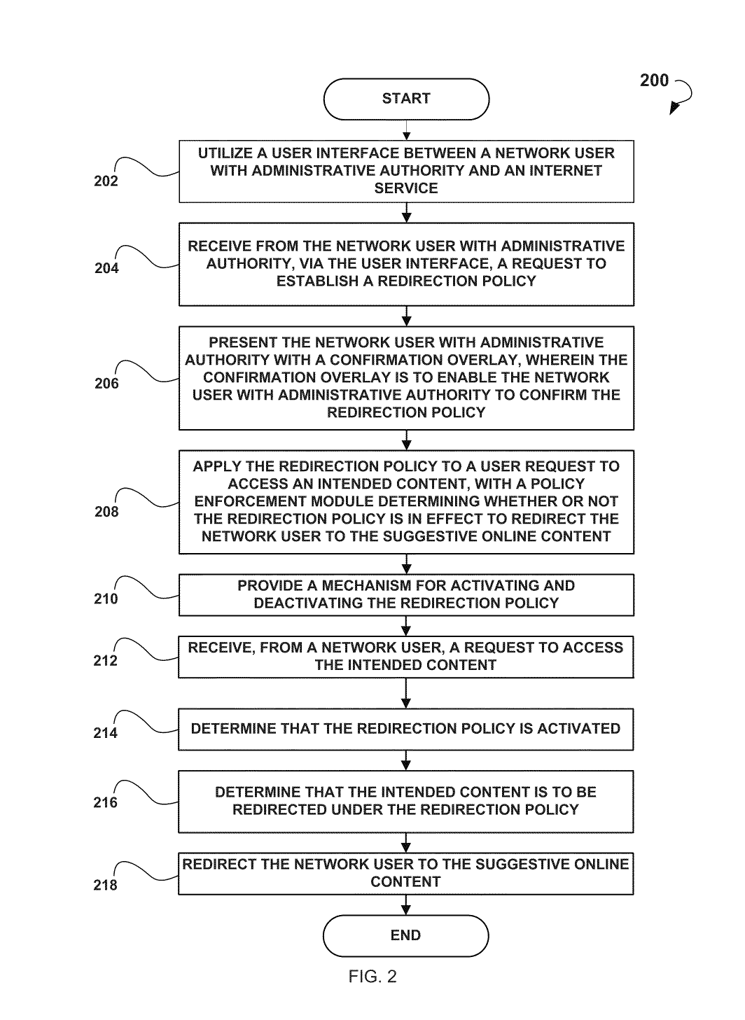

FIG. 2 illustrates a flow chart of a method 200 for suggestive redirection, in accordance with an exemplary embodiment. The method 200 may be performed by processing logic that may comprise hardware (e.g., dedicated logic, programmable logic, microcode, etc.), software (such as run on a general-purpose computer system or a dedicated machine), or a combination of both. In one exemplary embodiment, the processing logic resides at the redirection engine 100, as illustrated in FIG. 1.

The method 200 may be performed by the various modules discussed above with reference to FIG. 1. Each of these modules may comprise processing logic. The method 200 may commence at operation 202 with the user interface module 102 establishing the user interface 710 between the network user 660 with administrative authority and the DNS network 640. Using the user interface 710, the network user 660 with administrative authority may activate or deactivate the redirection policy and save configuration parameters for the redirection policy (e.g., by clicking the OK button). Thus, at operation 204, the communication module 104 may facilitate receiving a request from the network user 660 with administrative authority to establish the redirection policy. At operation 206, the redirection engine 100 may present the network user 660 with administrative authority with a confirmation overlay. The confirmation overlay may enable the network user 660 with administrative authority to confirm the redirection policy.

At operation 208, the policy enforcement module 108 may apply the redirection policy to a user request to access an intended content by determining whether or not the redirection policy is in effect to redirect the network user to the suggestive online content. At operation 210, the user interface 710 may provide a mechanism for activating and deactivating the redirection policy (e.g., by clicking on ON/OFF buttons).

At operation 212, the communication module 104 may receive, from the network user 660, a request to access the intended content. At operation 214, the policy enforcement module 108 may determine whether or not the redirection policy is in effect to redirect user requests by determining that the redirection policy is activated. At operation 216, the policy enforcement module 108 may determine that the intended content is to be redirected under the redirection policy and, at operation 218, redirect the network user 660 to the suggestive online content.

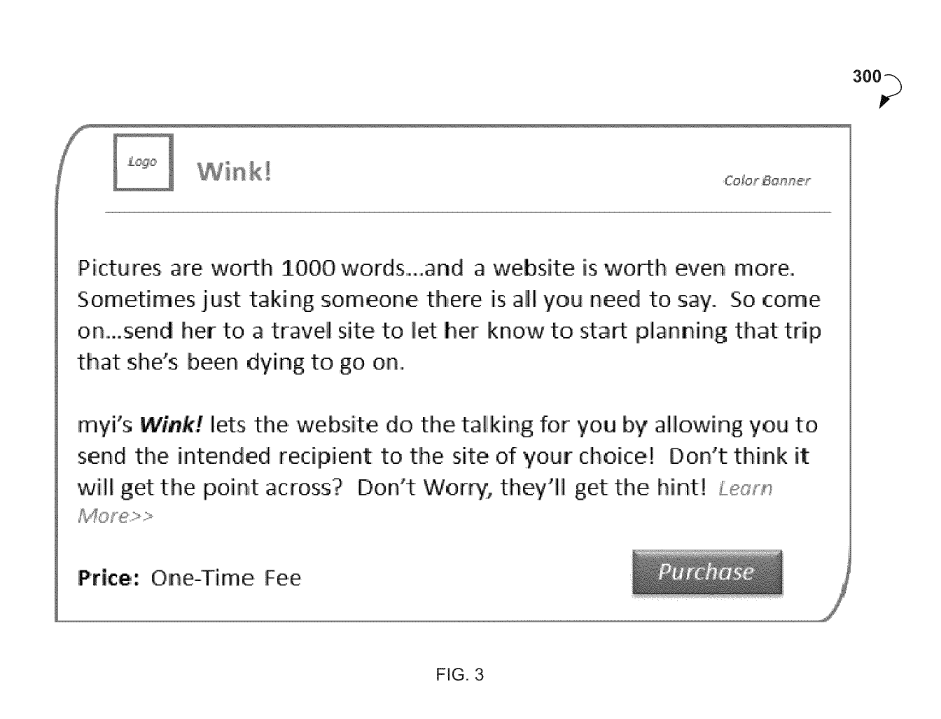

FIG. 3 is a screenshot of a configuration webpage 300 associated with a redirection policy application, in accordance with an exemplary embodiment. The description 300 may generally describe what the redirection policy does. As shown in FIG. 3, the description 300 may begin with one or more sentences describing the functionality of the redirection policy. The description 300 may provide the user with an example and invite the user to imagine the kind of reaction they would receive if they did what was outlined in the example. The example may be intended to help users understand the power and emotive responses that may occur. In some exemplary embodiments, the description 300 may outline steps in activating and deactivating the redirection policy. The description 300 may include a “Learn More” link that allows the network user 660 with administrative authority to receive more detailed information.

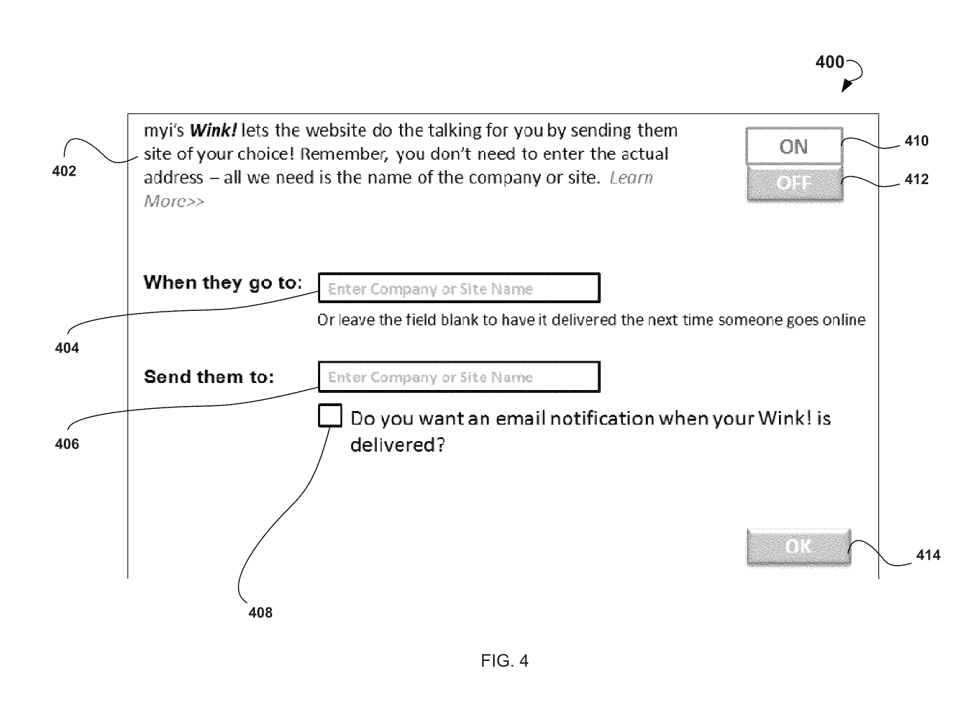

FIG. 4 is a screenshot of a configuration webpage 400. In some exemplary embodiments, the configuration webpage 400 may comprise a description text 402, an intended content name textbox 404, a suggestive online content name textbox 406, an email notification checkbox 408, an “ON” button 410, an “OFF” button 412, and an “OK” button 414.

In some exemplary embodiments, the functionality of the application 720 is accessible through the configuration webpage 400. While the design and layout may change between different implementations of exemplary embodiments, there may be a few components included in the configuration webpage 400. The description text 402 may include a brief summary of what the redirection policy does and how users may configure it. The description text 402 may begin with a sentence describing the application policy. It may then outline the steps in configuring application policy settings. The description text 402 may also provide the ability to learn more by clicking a “Learn More” link.

The network user 660 with administrative authority may specify which intended content is to prompt the redirection by inputting an intended website name in the intended content name textbox 404. This intended website name may include the recipient's favorite or frequently visited website. Accessing this website may cause the redirection to take place. The network user 660 with administrative authority may also select the suggestive online content he or she would like other users to be redirected to by inputting a website name in the suggestive online content name textbox 406.

It will be understood that when creating the settings, the network user 660 with administrative authority may be allowed to enter a company name or site name (e.g. Travelocity) in the appropriate field. The redirection engine 100 may determine the intended website based on the information provided. If the network user 660 with administrative authority wishes to disable the redirection policy, he or she may do so by clicking the “OFF” button 412. The network user 660 with administrative authority may alter these settings at any time. Thus, in addition to the initial setup, the configuration webpage 400 may be used to modify the settings of the redirection policy.

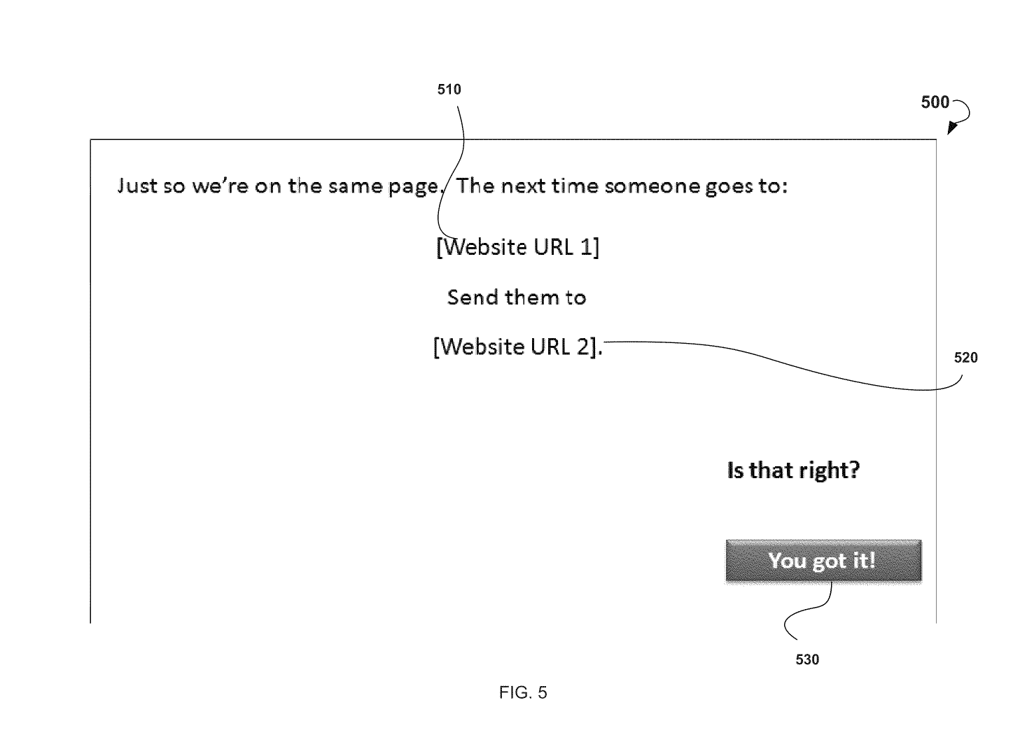

After the network user 660 with administrative authority is satisfied with the settings, he or she may click the “OK” button 414, which may present a confirmation overlay. The confirmation overlay is described in more detail with reference to FIG. 5 below.

FIG. 5 is a screenshot of a confirmation overlay 500 that informs the network user 660 with administrative authority which suggestive online content the redirection engine 100 may be using, based on their inputs. The confirmation overlay 500 may enable the network user 660 with administrative authority with another chance to edit inputs provided on the configuration webpage 400.

As shown in FIG. 5, the confirmation overlay 500 may comprise an intended website address 510, a suggestive content website address 520, and a confirmation button 530. The confirmation overlay 500 may inform the network user 660 with administrative authority that in the event that the redirection policy is activated and the network user 660 requests the intended website address 510, the network user 660 may be redirected to the suggestive content website address 520 instead of the requested website.

If the network user 660 with administrative authority finds the displayed information incorrect, he or she may be able to go back to the configuration webpage 400 and edit the settings. If, on the other hand, the network user 660 with administrative authority finds the displayed information correct, he or she may click the confirmation button 530 to implement the redirection policy.

The systems and methods described above may typically be resident in an Internet service or a DNS network. The systems and methods described may also be implemented in plug-in utilities, gateway devices, cable modems, proxy servers, set top boxes, and network interface devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

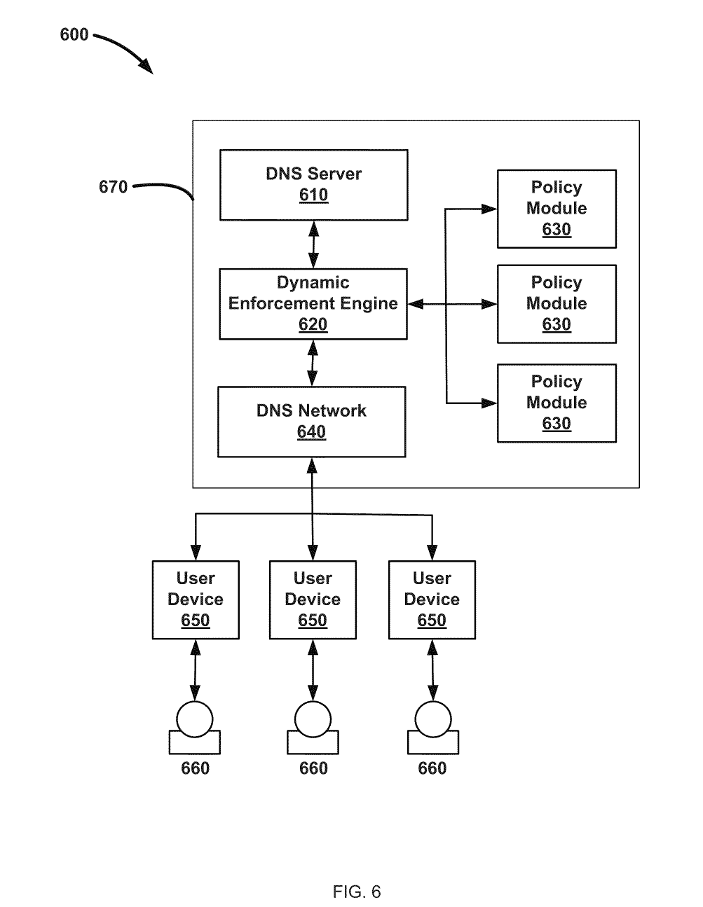

FIG. 6 illustrates an exemplary Internet service system 600, with a DNS Server 610, that may be utilized to support the above described systems and methods. A DNS Server 610 operates in conjunction with a dynamic enforcement engine 620. The dynamic enforcement engine 620 may operate in conjunction with one or more policy modules 630 to establish any applicable polices at the DNS Server 610 level. The content rules are applied to received user queries to determine which content is delivered by the DNS network 640 through various user devices 650 to the network users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more of the user devices 650.

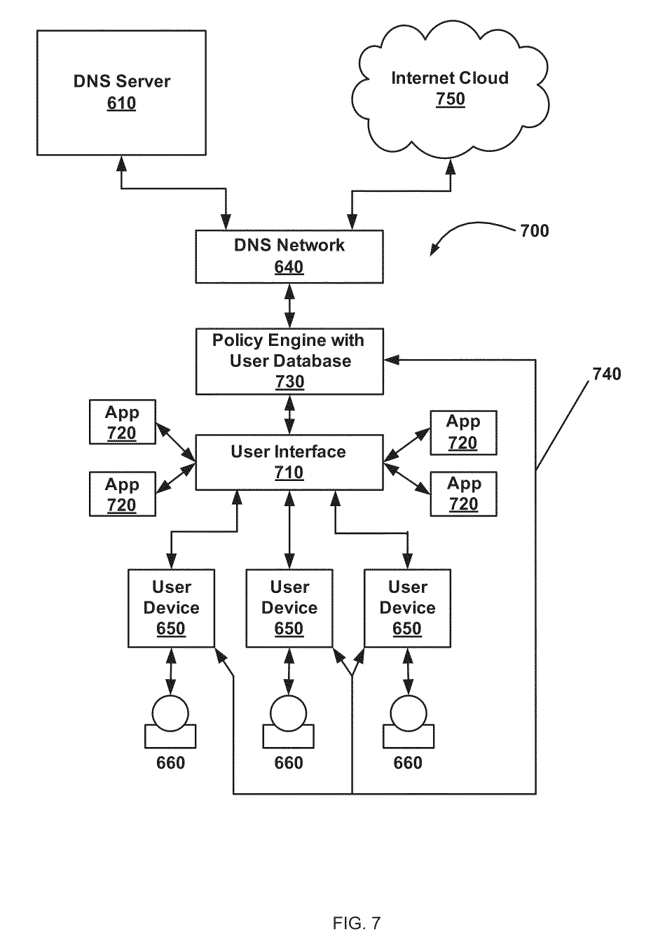

FIG. 7 shows a schematic layout of an exemplary system 700 for implementing direct and variable network user control. FIG. 7 illustrates that the system 700 may operate installed on a DNS Server 610, or with a cloud 750 based installation.

The system 700 utilizes a user interface 710. The user interface 710 may be implemented in many embodiments. One specific implementation of the user interface 710 is as a web page.

The user interface 710 may be accessed by one or more user devices 650 operated by the users 660. The user interface 710 may be accessed though a gateway user device 650 available to the users 660. Suitable user devices 650 include, but are not limited to, desktop computers, personal computers (PCs), laptops, notebooks, gaming devices, iPods, Smartphones, automobile computer systems, and Internet enabled Televisions (TVs). The system 700 may also be accessed and controlled remotely through user devices 650, such as Smartphones. A Smartphone may be defined as a phone with computing capability. A Smartphone may provide the user 660 with Internet access.

The user interface 710 provides a mechanism for one or more authorized users 660 to establish content policy for the Internet service. The user interface 710 operates between the user devices 650 present in the system 700 and the DNS network 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may prohibit access to specific Internet content. The policy applications 720 may also limit the time of day when users or selected users 660 may access certain Internet content. The policy applications 720 may also manage and analyze duration of access to various Internet content. It is important to note that the policy applications 720 do not simply provide blocking mechanisms by masking or enabling network controls, but rather mediate an Internet service received by the network user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when an Internet content is accessed. The policy applications 720 may also provide notification of frequency and duration of access of designated Internet content. The policy applications 720 may also be used to observe, substitute, enable, redirect users, reward behavior desired from the users by a system administrator, and so forth. The policy applications 720 may redirect users from non-favored Internet content to different Internet content. The policy applications 720 may also collect and transmit data characteristic of Internet use.

Access policies supplied by the policy applications 720 may apply to all users 660 of the system 700, or the access policies may be specific to individual users or groups of users 660. The policy applications 720 may be discrete, single purpose applications.

The policy applications 720 provide the users 660 with a mechanism to take various actions relative to their Internet service feed. The policy applications 720 also allow the users 660 to establish a dynamic policy engine 730 that includes a user database. The dynamic policy engine 730 is used to enforce rules associated with each policy application associated with individual network users, rather than simply block various inappropriate Internet content from the Internet feed. The dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize their Internet experience. The policy applications 720 may be configured in combinations and may each be separately configured.

The database in the dynamic policy engine 730 may be used to record and to notify users 660 of various data relative to Internet access. The data collected from and provided to the users 660 may include records of access of specific Internet content, time spent on specific Internet content, time of day of access, data specific to individual users, and so forth.

It should also be noted that following an initial setup through the user interface 710 of the dynamic policy engine 730, a direct access 740 enforcement loop may be established between the dynamic policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the dynamic policy engine 730 until such time as it may be modified by the system administrators. The system administrators may define multiple policy configurations, with a combination of policy applications 720, applicable to one or more network users 660 of the system 700. Each policy application 720 may also be separately configurable. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710 to the dynamic policy enforcement engine 730. A second data path 740 may be utilized following the establishment of a set of policies for the system 700. The second data path 740 flows directly between the user device(s) 650 and the dynamic policy engine 730. Multiple sets of enforcement policies may be established and saved within the system 700 and implemented selectively by the users 660.

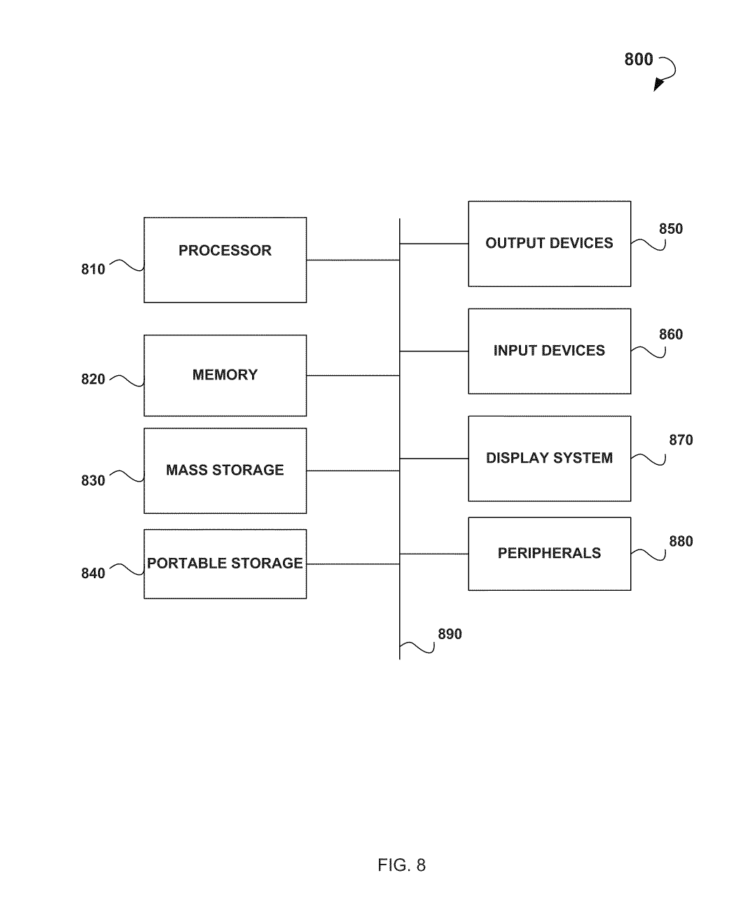

FIG. 8 illustrates an exemplary computing system 800 that may be used to implement an embodiment of the present invention. System 800 of FIG. 8 may be implemented in the context of user devices 650, DNS Server 610, Internet cloud 750 and the like. The computing system 800 of FIG. 8 includes one or more processors 810 and main memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a display system 870, and other peripheral devices 880.

The components shown in FIG. 8 are depicted as being connected via a single bus 890. The components may be connected through one or more data transport means. Processor 810 and main memory 820 may be connected via a local microprocessor bus, and the mass storage device 830, peripheral device(s) 880, portable storage medium drive 840, and display system 870 may be connected via one or more input/output (I/O) buses.

Mass storage device 830, which may be implemented with a magnetic disk drive or an optical disk drive, is a non-volatile storage device for storing data and instructions for use by processor 810. Mass storage device 830 can store the system software for implementing embodiments of the present invention for purposes of loading that software into main memory 820.

Portable storage medium drive 840 operates in conjunction with a portable non-volatile storage medium, such as a floppy disk, compact disk (CD), or digital video disc (DVD), to input and output data and code to and from the computer system 800 of FIG. 8. The system software for implementing embodiments of the present invention may be stored on such a portable medium and input to the computer system 800 via the portable storage medium drive 840.

Input devices 860 provide a portion of a user interface. Input devices 860 may include an alpha-numeric keypad, such as a keyboard, for inputting alpha-numeric and other information, or a pointing device, such as a mouse, trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a PC, hand held computing device, telephone, mobile computing device, workstation, server, minicomputer, mainframe computer, or any other computing device. The computer can also include different bus configurations, networked platforms, multi-processor platforms, and so forth. Various operating systems can be used, including UNIX, Linux, Windows, Macintosh OS, Palm OS, and other suitable operating systems.

Some of the above-described functions may be composed of instructions that are stored on storage media (e.g., a computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a Central Processing Unit (CPU) for execution. Such media can take many forms, including, but not limited to, non-volatile media, volatile media and transmission media. Non-volatile media include, for example, optical or magnetic disks, such as a fixed disk. Volatile media include dynamic memory, such as system Random Access Memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service. One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein. One skilled in the art will further appreciate that the term “Internet content” comprises encompasses any content that may be accessed by an Internet access user device including but not limited to one or more of web sites, domains, web pages, web addresses, hyperlinks, URLs, any text, pictures, and/or media (such as video, audio, and any combination of audio and video) provided or displayed on a web page, and any combination thereof. Redirection polices may include any of blocking, constraining, enabling, redirecting, promoting, demoting, substituting, obscuring, limiting, interrupting.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for suggestive redirection, the method comprising:
utilizing a user interface between a first user in a network and an Internet service;
receiving from the first user via the user interface, a request to establish a redirection policy; and
applying the redirection policy to a second user requesting access to Internet content, with a policy enforcement module determining whether or not the access request meets the redirection policy and redirecting the second user to Internet content designated by the first user if the redirection policy is applicable to the access request.

2. The method of claim 1, wherein the user interface provides a mechanism for activating and deactivating the redirection policy.

3. The method of claim 1, wherein the designated content is Internet content desired by the first user to suggest to the second user one or more of a hint, a reconciliation, an idea, an interest, a vacation, a purchase, a healthy habit, an activity, an event, humor, and a program.

4. The method of claim 1, wherein network user parameters associated with the redirection policy are accessible by a network user with administrative authority through a configuration webpage.

5. The method of claim 4, wherein the network user with administrative authority can disable or cancel a redirection policy.

6. The method of claim 1, wherein multiple redirection policies can be enabled for a single end user.

7. The method of claim 1, where the determination whether or not the redirection policy is in effect to redirect the first user in the network to the suggestive online content comprises:
determining that the redirection policy is activated;
determining that the intended content is to be redirected under the redirection policy; and
based on the determination, selectively redirecting the network user to the suggested online content.

8. The method of claim 1, further comprising informing the first user the redirection policy was activated by the second user.

9. The method of claim 1, further comprising informing the network user with administrative authority of one or more of the following: a particular redirection and an aggregated number of redirections.

10. The method of claim 1, wherein the redirection policy comprises a category of Internet content.

11. The method of claim 1, wherein the Internet system transmits a redirection policy message to the second user a number of times specified by the first user.

12. The method of claim 1, wherein at least one element of the redirection policy is resident on the DNS server.

13. The method of claim 1, wherein at least one element of the redirection policy is enforced by the DNS server.

14. The method of claim 1, wherein the mediation policy is created by a collaborative effort from more than one user.

15. The method of claim 15, wherein at least one user is not a user of the network to which the mediation policy is applied.

16. A system for suggestive redirection, the system comprising:
a user interface module to provide a user interface between a first user in a network and an Internet service;
a communication module to receive from the first user, via the user interface, a request to establish a redirection policy;
a policy generating module to establish the redirection policy; and
a policy enforcement module to apply the redirection policy to a second user requesting access to an intended content, wherein the policy enforcement module determines whether or not the redirection policy is in effect to redirect the second user to Internet content designated by the first user.

17. The system of claim 16, further comprising a policy activation module to activate and deactivate the redirection policy.

18. The system of claim 16, wherein the Internet content is Internet content intended by the first user to suggest one or more of the following: a hint, a vacation, a purchase, an idea, an interest, a healthy habit, an activity, an event, and a program.

19. The system of claim 16, further comprising a confirmation overlay to enable the network user with administrative authority to confirm the redirection policy.

20. The system of claim 16, further comprising a configuration webpage including parameters associated with the redirection policy, the configuration webpage accessible by the network user with administrative authority.

21. The system of claim 16, wherein the policy enforcement module is to:
determine that the redirection policy is activated;
determine that the intended content is to be redirected under the redirection policy; and
based on the determination, selectively redirecting the network user to the suggestive online content.

22. The system of claim 21, wherein the policy enforcement module is to identify the network user with administrative authority to the network user.

23. The system of claim 21, wherein the policy enforcement module is to inform the network user of the redirection policy.

24. The system of claim 21, further comprising an information module to inform the network user with administrative authority of one or more of the following: a particular redirection and an aggregated number of redirections.

25. The system of claim 21, further comprising an information module to inform the network user with administrative authority of the suggestive online content involved in the redirection.

26. The system of claim 16 wherein at least one element of the redirection policy is resident on a DNS server.

27. The system of claim 16, wherein at least one element of the redirection policy is enforced by the DNS server.

28. A computer readable storage medium having a program embodied thereon, the program executable by a processor in a computing device to perform a method for suggestive redirection, the method comprising:
utilizing a user interface between a first user in a network and an Internet service;
receiving from the first user, via the user interface, a request to establish a redirection policy; and
applying the redirection policy to a second user requesting access to an intended content, with a policy enforcement module determining whether or not the redirection policy is in effect to redirect the second user to a suggestive online content designated by the first user.

29. A method for suggestive redirection, the method comprising:
utilizing a user interface between a first user in a network and a Internet service;
receiving from the first user via the user interface, a request to establish a redirection policy in the DNS server; and
applying the redirection policy to a second user requesting access to an intended content, with a DNS server determining whether or not the redirection policy is in effect to redirect the second user to a Internet content designated by the first user if the redirection policy is applicable to the access request.

30. The method of claim 29, wherein the user interface provides a mechanism for activating and deactivating the redirection policy in the DNS server.

31. The method of claim 29, wherein the Internet content is to suggest to the second user one or more of a hint, a vacation, a purchase, a healthy habit, an activity, an event, an idea, an interest, humor, and a program.

32. The method of claim 29, wherein network user parameters associated with the redirection policy in the DNS server are accessible by a network user with administrative authority through a configuration webpage.

33. The method of claim 32, wherein the network user with administrative authority can disable or cancel a redirection policy in the DNS server.

34. The method of claim 29, wherein multiple redirection policies in the DNS server can be enabled for a single end user.

35. The method of claim 29, where the determination whether or not the redirection policy is in effect in the DNS server to redirect the first user in the network to the suggestive online content comprises:
determining that the redirection policy is activated;
determining that the intended content is to be redirected under the redirection policy; and
based on the determination, selectively redirecting the network user to the suggested online content.

36. The method of claim 29, further comprising informing the first user the redirection policy was triggered by DNS server for the second user.

37. The method of claim 29, further comprising informing the network user with administrative authority of one or more of the following: a particular redirection and an aggregated number of redirections.

38. The method of claim 29, wherein the redirection policy comprises a category of Internet content.

39. The method of claim 29, wherein the DNS server redirects requests by the second user a number of times specified by the first user.

40. The method of claim 29, wherein the mediation policy is created by a collaborative effort from more than one user.

41. The method of claim 40, wherein at least one user is not a user of the network to which the mediation policy is applied.

42. The method of claim 29, the user with administrative authority specifies different redirection polices for different locations.

43. The method of claim 29, wherein at least a portion of the Internet service resides on a user device.

44. A system for suggestive redirection, the system comprising:
a user interface module to provide a user interface between a first user in a network and a DNS server;
a communication module to receive from the first user, via the user interface, a request to establish a redirection policy;
a policy generating module to establish the redirection policy; and
a policy enforcement module to apply the redirection policy to a second user requesting access to Internet content, wherein the policy enforcement module determines whether or not the access request meets the redirection policy and redirects the second user to a suggestive online content designated by the first user if the redirection policy is applicable to the access request.

45. The system of claim 44, further comprising a policy activation module to activate and deactivate the redirection policy.

46. The system of claim 44, wherein the suggestive online content is to suggest one or more of the following: a hint, a vacation, a purchase, a healthy habit, an activity, an event, and a program.

47. The system of claim 44, further comprising a confirmation overlay to enable the network user with administrative authority to confirm the redirection policy.

48. The system of claim 44, further comprising a configuration webpage including parameters associated with the redirection policy, the configuration webpage accessible by the network user with administrative authority.

49. The system of claim 44, wherein the policy enforcement module is to:
determine that the redirection policy is activated;
determine that the intended content is to be redirected under the redirection policy; and
based on the determination, selectively redirecting the network user to the suggestive online content.

50. The system of claim 49, wherein the policy enforcement module is to identify the network user with administrative authority to the network user.

51. The system of claim 49, wherein the policy enforcement module is to inform the network user of the redirection policy.

52. The system of claim 49, further comprising an information module to inform the network user with administrative authority of one or more of the following: a particular redirection and an aggregated number of redirections.

53. The system of claim 49, further comprising an information module to inform the network user with administrative authority of the suggestive online content involved in the redirection.

54. The system of claim 49, wherein at least a portion of the Internet service resides on a user device.
